(19) United States
(12) Patent Application Publication
(10) Pub. No.: US 2026/0006688 A1
(43) Pub. Date: Jan. 1, 2026

(54) Vehicle Headlight Deicing Film Device

(71) Applicant: SHU-LIEN CHEN, Taichung City (TW)

(72) Inventor: SHU-LIEN CHEN, Taichung City (TW)

(21) Appl. No.: 19/231,599

(22) Filed: Jun. 9, 2025

(30) Foreign Application Priority Data
Jun. 28, 2024 (TW) 113124461

(51) Int. Cl. H05B 6/70; B60Q 1/00; H05B 6/64

(52) U.S. Cl. CPC H05B 6/707; H05B 6/6444; B60Q 1/0005; H05B 2214/02

(57) ABSTRACT

A vehicle headlight deicing film device includes a lamp assembly and a deicing film device is arranged in a housing of the lamp assembly. The deicing film device includes a microwave generator and a waveguide tube. The microwave generator generates and outputs a microwave. The waveguide tube guides the microwave output by the microwave generator out of a reflector of the lamp assembly and transmits the microwave to a lens of the lamp assembly. The microwave acts on the ice film on the outer surface of the lens, and the solid and hard state of the ice film begins to loosen, making it easy to separate from the lens.

### BACKGROUND OF THE PRESENT INVENTION

### Field of Invention

The present invention relates to a deicing device, and more particularly to a vehicle headlight deicing film device.

### Description of Related Arts

When the temperature is below 0 degrees Celsius, rain will freeze into a thin layer of ice film when it touches the ground or colder objects on the ground. Meteorological science refers to this weather phenomenon as “freezing rain.” Freezing rain is a mixture of ice and water that looks like ordinary raindrops but freezes into a thin layer of ice on the surface of an object.

If the ice film caused by freezing rain adheres to the vehicle, it will affect the driving safety, and the ice film should be removed before the vehicle is driven on the road. Conventional methods of removing ice film include hot water deicing, warm air or hot temperature deicing, and physical deicing, etc. Each of these methods has its own advantages and disadvantages, and special care should be taken when using them.

The utilization of hot water in the process of deicing is known to result in the rapid dissolution of ice. However, the vehicle's windows glass, and plastic components are susceptible to damage from sudden and drastic temperature fluctuations. This can have a detrimental effect on the vehicle body and its plastic components.

The utilization of warm air or hot temperature deicing methods, such as turning on the vehicle heater to raise the overall temperature of the vehicle body or starting the heating wire to heat the objects attached by the ice film, in order to melt the ice film. This method of heating is relatively mild, but the disadvantage is that it takes a long time. If the use of the vehicle is in a hurry, this kind of deicing method is slow. Sometimes, due to severe cold weather, these mild heating methods are unable to raise the temperature of the object high enough to melt the ice film.

The physical deicing method is to use tools such as ice shovels or ice chisels to apply external forces such as knocking and scraping to the ice film so that the ice film breaks into small pieces that are easily detached from the attached objects. However, if the force of the external force is not properly controlled, it usually takes a lot of force to break through the hard ice film, so that when the ice film breaks, the attached objects are also damaged.

If the ice film is attached to the headlight cover of the vehicle, the use of hot water deicing or physical deicing will easily cause the headlight cover to crack. If the deicing method of hot temperature (electric heating wire) is used, the time required is too long. If the ice film is not removed, the light from the headlight will be blocked by the ice film or produce unexpected refraction, which will seriously affect driving safety.

### SUMMARY OF THE PRESENT INVENTION

In order to solve the above problems, the present invention provides a vehicle headlight deicing film device.

### Technical Features of the Present Invention

A vehicle headlight deicing film device, including a lamp assembly, wherein a vehicle power supply supplies power to the lamp assembly, wherein at least one light source is arranged in the housing, a lens is attached to an opening of the housing, wherein the lens allows light emitted from the light source to pass through for lighting, and a reflector is arranged in the housing around the light source, wherein the reflector reflects the light emitted by the light source, wherein a deicing film device is arranged in the housing, and the deicing film device is electrically connected with the vehicle power supply, wherein the deicing film device includes a microwave generator and a waveguide tube, wherein the microwave generator generates and outputs a microwave, wherein the waveguide tube has a first end disposed at a microwave output end of the microwave generator and a second end with an outlet disposed at the reflector, wherein the waveguide tube guides the microwave output by the microwave generator out of the reflector and transmits the microwave to the lens.

### Effects of the Present Invention

The microwave output by the microwave generator penetrates the lens and acts on the ice film attached to the outer surface of the lens. The free water molecules mixed in the ice film are oscillated by the microwave, causing the ice film to be delaminated. The solid and hard state of the ice film begins to loosen, and the tight fixation relationship between the ice film and the lens is locally loosened. The delamination and loosening phenomenon will be transmitted with the oscillation of the water molecules, and the delamination and loosening area will become larger and larger. At this time, hand tools such as ice shovels or ice chisels can be used to gently touch and hit the ice film, and the ice film can collapse over a large area and detach from the lens.

The purpose of the present invention is not to melt the ice film completely, but to make the ice film delaminate and loosen in a relatively short period of time, so as to facilitate its removal by physical means with ease and light force.

The power and frequency defined by the present invention do not interfere with the communication radio waves of the vehicle, and make the water molecules in the ice film oscillate without generating high heat energy, thereby preventing the lens from being broken due to extreme temperature changes.

### BRIEF DESCRIPTION OF THE DRAWINGS

FIG. 1 is a sectional view of the deicing film device installed on a vehicle headlight according to the present invention.

FIG. 2 is a schematic view describing the deicing process in accordance with FIG. 1.

### DETAILED DESCRIPTION OF THE PREFERRED EMBODIMENT

In order to facilitate the explanation of the central idea of the present invention as indicated in the above-mentioned invention content, the following will describe the implementation methods of the present invention with reference to the drawings and embodiments. The drawings provided in the following embodiments are only used to schematically illustrate the basic concept of the present invention. Therefore, the drawings only show components related to the present invention rather than being drawn according to the number, shape, structural layout and size of components in actual implementation. The type, quantity, proportion and layout of each component in actual implementation are all changeable.

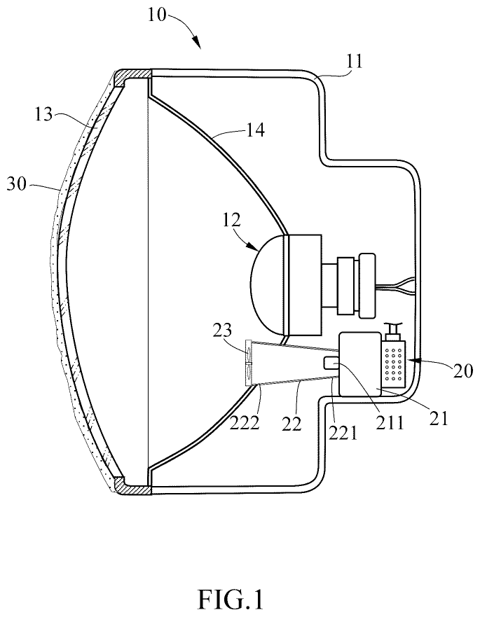

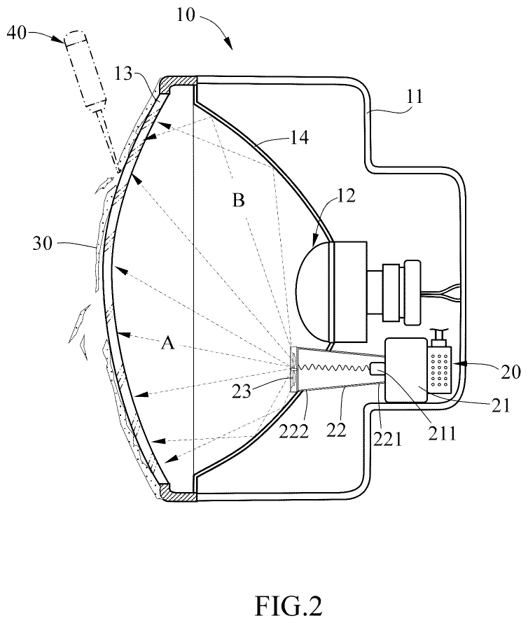

As shown in FIG. 1 and FIG. 2, a lamp assembly 10 of a motor vehicle is shown. The lamp assembly 10 is a headlight component. This is exemplary but not restrictive. Therefore, it can be understood that other lamp assemblies 10 such as taillight assembly, turn signal assembly, and fog light assembly may also be included in the scope of the present invention.

The lamp assembly 10 includes a housing 11, at least one light source 12 arranged in the housing 11, and a lens 13 is attached to an opening of the housing 11. The lens 13 has an inner surface facing the light source 12 and an outer surface facing away from the light source 12, and the lens 13 allows light emitted from the light source 12 to pass through for illumination. A reflector 14 is arranged in the housing 11 around the light source 12. Preferably, the reflector 14 is made of metal, or the plastic material is coated with a layer of film that is conducive to reflecting the illuminant on the surface facing the light source 12.

A deicing film device 20 is arranged in the housing 11. The light source 12 and the deicing film device 20 are electrically connected with a vehicle power source (not shown).

The deicing film device 20 includes a microwave generator 21, a waveguide tube 22, and a diffuser 23.

The microwave generator 21 generates and outputs a microwave. The microwave output power (W) and microwave frequency (MHz) are in accordance with the regulations of the national energy public department on household food cooking appliances. For example, the power of a household microwave oven is 600 W˜1200 W, and the frequency is 2450 MHz. Preferably, the power of the microwave generator 21 used in the present invention is less than 600 W. Preferably, the power of the microwave generator used in the present invention is 50 W to 300 W. The microwave frequency defined by the present invention can avoid the interference of automobile communication radio waves.

The waveguide tube 22 has a first end 221 disposed at a microwave output end 211 of the microwave generator 21 and a second end 222 with an outlet disposed at the reflector 14. The diffuser 23 is disposed at the second end 222. The waveguide tube 22 guides the microwave output by the microwave generator 21 out of the reflector 14, wherein the microwave is dispersed by the diffuser 23, so that the output dispersed microwaves are transmitted between the reflector 14 and the lens 13 through a direct path (such as arrow A) and a reflected path (such as arrow B) and distributed to the lens 13.

In the illustration, an ice film 30 is attached to the outer surface of the lens 13 due to the weather pattern described in the prior art. The ice film 30 is a mixture of ice and water, but is attached to the lens 13 in the form of a thin ice layer. Ice is a solid formed by water molecules tightly bound together, and the water molecules in the solid are not free, but there is still a small amount of water in the ice film 30, and the water molecules of these water are free and will oscillate under the action of the microwave electric field.

The microwave output by the microwave generator 21 penetrates the lens 13 and acts on the ice film 30, and the free water molecules mixed with the ice film 30 are oscillated by the microwave, causing the ice film 30 to be delaminated. The solid and hard state of the ice film 30 begins to loosen, and the tight fixation relationship between the ice film 30 and the lens 13 also loosens locally. The delamination and loosening phenomenon will be transmitted with the oscillation of the water molecules, and the delamination and loosening area will become larger and larger. At this time, a hand tool 40 such as an ice shovel or an ice chisel can be used to gently tap the ice film 30, and the ice film 30 will collapse in a large area and detach from the lens 13.

The purpose of the present invention is not to melt the ice film 30 completely, but to make the ice film 30 delaminate and loosen in a relatively short period of time, thereby facilitating the removal of the ice film 30 through a physical method in an effortless and little effort manner.

Taking a microwave with a power of 300 W and a frequency of 2450 MHz as an example, it takes about 20 seconds for the ice film 30 to undergo the above-mentioned delamination and loosening. The power and frequency defined in the present invention do not interfere with the communication radio waves of the vehicle, and make the water molecules in the ice film 30 oscillate without generating high heat energy, thereby preventing the lens 13 from being broken due to extreme temperature changes.

What is claimed is:

1. A vehicle headlight deicing film device, comprising a lamp assembly, wherein a vehicle power supply supplies power to the lamp assembly, wherein the lamp assembly comprises a housing, at least one light source arranged in the housing, a lens attached to an opening of the housing, wherein the lens allows light emitted from the light source to pass through for lighting, and a reflector arranged in the housing around the light source, wherein the reflector reflects the light emitted by the light source, wherein
a deicing film device is arranged in the housing, and the deicing film device is electrically connected with the vehicle power supply, wherein the deicing film device comprises a microwave generator and a waveguide tube,
wherein the microwave generator generates and outputs a microwave,
wherein the waveguide tube has a first end disposed at a microwave output end of the microwave generator and a second end with an outlet disposed at the reflector, wherein the waveguide tube guides the microwave output by the microwave generator out of the reflector and transmits the microwave to the lens.

2. The vehicle headlight deicing film device, as recited in claim 1, further comprising a diffuser, wherein the diffuser is arranged at the second end, wherein the microwave is transmitted to the lens via the diffuser between the reflector and the lens in a direct path and a reflected path.

3. The vehicle headlight deicing film device, as recited in claim 1, wherein the power of the microwave generator is 50 W˜300 W and the frequency is 2450 MHz.
